(19) United States
(12) Patent Application Publication
(10) Pub. No.: US 2012/0294568 A1
(43) Pub. Date: Nov. 22, 2012

(54) Alignment Method for a Silicon Photonics Packaging

(75) Inventors: Jing Zhang, Singapore (SG); Jeong Hwan Song, Singapore (SG); Huijuan Zhang, Singapore (SG); Shiyi Chen, Singapore (SG)

(73) Assignee: Agency for Science, Technology and Research

(21) Appl. No.: 13/475,008

(22) Filed: May 18, 2012

(30) Foreign Application Priority Data
May 18, 2011 (SG) 201103542-5

(51) Int. Cl. G02B 6/42

(52) U.S. Cl. 385/50

(57) ABSTRACT

According to embodiments of the present invention, an alignment method for a silicon photonics packaging is provided. The method includes providing a plurality of waveguides, each of the plurality of waveguides including an input and an output, arranging a light source relative to the plurality of waveguides, the light source being configured to provide an input light to the input of at least one of the plurality of waveguides, detecting respective output light intensity exiting the outputs of the plurality of waveguides, and identifying based on the detected output light intensity a selected waveguide of the plurality of waveguides for subsequent coupling.

This application claims the benefit of priority of Singapore patent application No. 201103542-5, filed May 18, 2011, the content of it being hereby incorporated by reference in its entirety for all purposes.

### FIELD OF THE INVENTIONS

Various embodiments relate to an alignment method for a silicon photonics packaging.

### BACKGROUND OF THE INVENTIONS

A silicon waveguide is a high-index-contrast waveguide. High-index-contrast dielectric waveguides exhibit highly confined optical modes. The tight confinement allows for waveguides to be placed closely together without inducing cross talk. Hence, silicon photonics circuit can be integrated with high density. However, the tight confinement causes difficulty in the optical connection of silicon photonics chip to other optical devices or components. Even with mode size converters integrated with the silicon waveguides (e.g. reverse tapers are often used to enlarge the mode size of the silicon waveguide), the optical connection needs highly accurate alignment, placement and attachment.

Transceivers are key devices in high-speed optical interconnects. In communication networks, a transceiver includes a transmitter which converts the electrical signals into optical signals, and a receiver which receives, amplifies and reshapes the optical signals into electrical signals. A typical transceiver has a directly modulated laser source, a photodiode which is III-V material based and an optical interface for coupling with the optical fiber(s). Silicon photonics is a promising technology for low cost optical transceivers. Waveguides, optical filters, modulators, and photodetectors can be integrated by CMOS compatible processes on a single silicon chip to fulfill the transceiver's functions. Electrical drivers and amplifiers can be furthermore integrated with the silicon photonics circuit on one chip.

However, the lack of a silicon light source remains the show-stopper for full monolithic integration. Hybrid integration of an external III-V laser diode using assembly techniques is required, which is an immense challenge in packaging. An alternative solution is to integrate or bond a hybrid III-V laser diode on the Si-substrate. Unfortunately, CMOS and III-V process integration is hardly a trivial task.

Much research has been done in the field of silicon photonics packaging to improve the coupling efficiency, such as: embedded laterally tapered rib waveguide coupler, tapered structure for making the mode larger and mode size converter integrated in the substrate with additional waveguides based on interference between two or three mode coupling. These are aimed at high coupling efficiency between the waveguides and the optical fibers, by converting the mode size from the silicon waveguides to match with the mode of the single mode fibers.

The increased mode size will help to improve the coupling efficiency and enlarge alignment tolerance for fiber assembly. However, it does not work for laser diodes to silicon waveguides coupling. The spot size from the laser diode is about 2 μm to 2.5 μm width. To couple the light from the laser diode to the waveguide efficiently, the mode size of the waveguide needs to match with the mode size or beam from the laser diode. However, due to the very small mode sizes, the alignment tolerance is very small. To further increase the mode size of the waveguide will enlarge the alignment tolerance but will decrease the coupling efficiency.

The mode size from a reverse tapered nano-tip is about 2 μm width, which matches with that of the laser diode. Therefore, the coupling between a reverse-tapered waveguide and a laser diode would have high efficiency if the two are aligned well.

Using reverse taper or mode converter in silicon waveguides for laser diode to silicon waveguide coupling will have tight assembly tolerances. The mode size converter with additional waveguides based on interference between two or three mode coupling will have a larger lateral alignment tolerance. However, the fabrication error in the waveguides and combiner may cause the optical power to decrease due to the optical phase mismatching in different paths.

As the assembly tolerance is very tight, very high precision alignment and assembly process is required. A +/−1 μm shift will reduce the coupling efficiency by about 3 dB. As an illustration, based on simulation, the spot size from a laser and the beam size from the reverse taper tip may be assumed to be about 2 μm, with the coupling efficiency normalized. The flip chip bonding machine has a +/−1 μm accuracy or alignment error. The laser diode will contribute about +/−0.5 μm alignment error due to the alignment between the alignment mark and the waveguide. A +/−1.5 μm shift will reduce the coupling efficiency by approximately 6 dB. Besides, post-bonding shift will add further uncertainty in the laser diode assembly, to the laser to waveguide alignment, which is up to 0.5 μm to 2 μm. Furthermore, the laser diode position cannot be adjusted after fixing. Therefore, the yield for the laser diode attachment is very low.

### SUMMARY

According to an embodiment, an alignment method for a silicon photonics packaging is provided. The method may include providing a plurality of waveguides, each of the plurality of waveguides including an input and an output, arranging a light source relative to the plurality of waveguides, the light source being configured to provide an input light to the input of at least one of the plurality of waveguides, detecting respective output light intensity exiting the outputs of the plurality of waveguides, and identifying based on the detected output light intensity a selected waveguide of the plurality of waveguides for subsequent coupling.

According to an embodiment, an alignment method for a silicon photonics packaging is provided. The method may include providing at least two waveguides, each of the at least two waveguides including an input and an output, arranging a light source along a substantially center axis between the at least two waveguides, the light source being configured to provide an input light to respective inputs of the at least two waveguides, arranging a combiner in optical communication with the respective outputs of the at least two waveguides so as to combine respective output light exiting from the at least two waveguides to produce a combined light, and arranging an optical fiber in optical communication with the combiner so as to receive the combined light exiting from the combiner for subsequent coupling.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIG. 1A shows a flow chart illustrating an alignment method for a silicon photonics packaging, according to various embodiments.

FIG. 1B shows a flow chart illustrating an alignment method for a silicon photonics packaging, according to various embodiments.

FIGS. 2A to 2D show perspective views of an alignment method for a silicon photonics packaging, according to various embodiments.

FIGS. 3A and 3B show respectively the simulated results for the contour map of the x-component of electric field (Ex) and a plot of the coupling between two waveguide tips with a spacing of about 2 μm.

FIGS. 3C and 3D show respectively the simulated results for the contour map of the x-component of electric field (Ex) and a plot of the coupling between two waveguide tips with a spacing of about 1.8 μm.

FIGS. 3E and 3F show respectively the simulated results for the contour map of the x-component of electric field (Ex) and a plot of the coupling between two waveguide tips with a spacing of about 1.6 μm.

FIG. 4 shows a perspective view of a silicon photonics packaging with an alignment method of various embodiments.

FIG. 5A shows a plot of normalized coupling efficiency between a light source and three silicon waveguides, according to various embodiments.

FIG. 5B shows a plot of normalized coupling efficiency between a light source and a single silicon waveguide of the prior art.

FIG. 6 shows scanning electron microscope (SEM) images of fabricated waveguides, according to various embodiments.

FIG. 7 shows a perspective view of an alignment method for a silicon photonics packaging, according to various embodiments.

FIG. 8 shows a scanning electron microscope (SEM) image of a top view of a two-dimensional (2D) grating.

FIG. 9 shows a plot of normalized coupling efficiency between a light source and two silicon waveguides with a combiner, according to various embodiments.

### DETAILED DESCRIPTION OF THE INVENTIONS

The following detailed description refers to the accompanying drawings that show, by way of illustration, specific details and embodiments in which the invention may be practiced. These embodiments are described in sufficient detail to enable those skilled in the art to practice the invention. Other embodiments may be utilized and structural, logical, and electrical changes may be made without departing from the scope of the invention. The various embodiments are not necessarily mutually exclusive, as some embodiments can be combined with one or more other embodiments to form new embodiments.

Embodiments described in the context of one of the methods or devices are analogously valid for the other method or device. Similarly, embodiments described in the context of a method are analogously valid for a device, and vice versa.

In the context of various embodiments, the phrase “at least substantially” may include “exactly” and a variance of +/−5% thereof. As an example and not limitations, “A is at least substantially same as B” may encompass embodiments where A is exactly the same as B, or where A may be within a variance of +/−5%, for example of a value, of B, or vice versa.

In the context of various embodiments, the term “about” or “approximately” as applied to a numeric value encompasses the exact value and a variance of +/−5% of the value.

As used herein, the term “and/or” includes any and all combinations of one or more of the associated listed items.

Various embodiments may provide a method to enhance the tolerance of light source (e.g. laser diode) horizontal alignment in a silicon photonics packaging. In other words, various embodiments may provide a method to enhance alignment tolerance in (silicon) photonics packagings. Therefore, various embodiments may provide a method to increase the assembly tolerance for light source attachment with silicon photonics waveguides. As a non-limiting example, the method may include placing or arranging three silicon (Si) waveguides at least substantially in parallel with each other, with a suitable spacing, e.g. about 2 μm spacing, in between adjacent waveguides for a light source (e.g. a laser diode) to align. The horizontal 3 dB tolerance may be extended to approximately +/−3 μm.

Various embodiments may provide a multi-waveguide-method to enhance the tolerance of horizontal alignment in a silicon photonics packaging by placing identical and independent silicon waveguides in parallel with a suitable soacing, e.g. a 2 μm spacing, in between the waveguides for the flip chip bonding of a light source (e.g. laser diode). In various embodiments, there may be minimal or no interference between the waveguides or their associated circuits.

In various embodiments, the horizontal 3.4 dB tolerance may be extended to approximately +/−2 μm when two independent and identical waveguides are used. By using a combiner (e.g. a two-dimensional (2D) grating), the lights in the two waveguides may be combined and coupled into an optical fiber. In various embodiments, the horizontal 3.4 dB tolerance may be extended to approximately +/−3 μm when three independent and identical waveguides are used. The number of waveguides employed in various embodiments may not be limited to two or three, and may include four, five or any higher number of waveguides. The number of waveguides employed may be determined by the accumulated misalignment during the assembly process.

Various embodiments of the method and silicon photonics packaging have simple silicon chip fabrication steps, a larger horizontal assembly tolerance and consequently providing a higher yield. Furthermore, various embodiments may have industrial applications for silicon photonics integration with III-V laser diodes, for example for optical transceivers and integrated silicon photonics circuits.

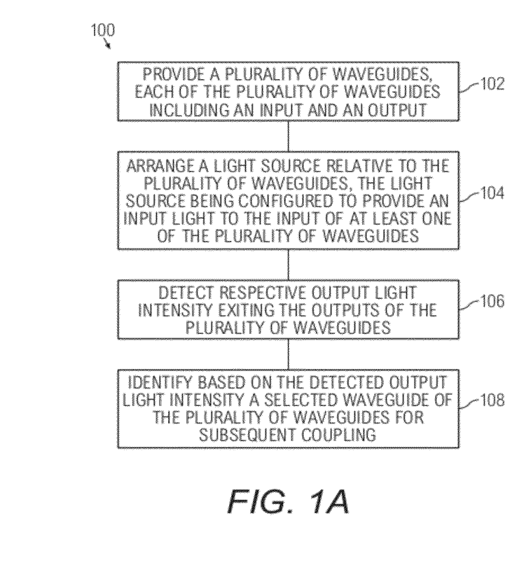

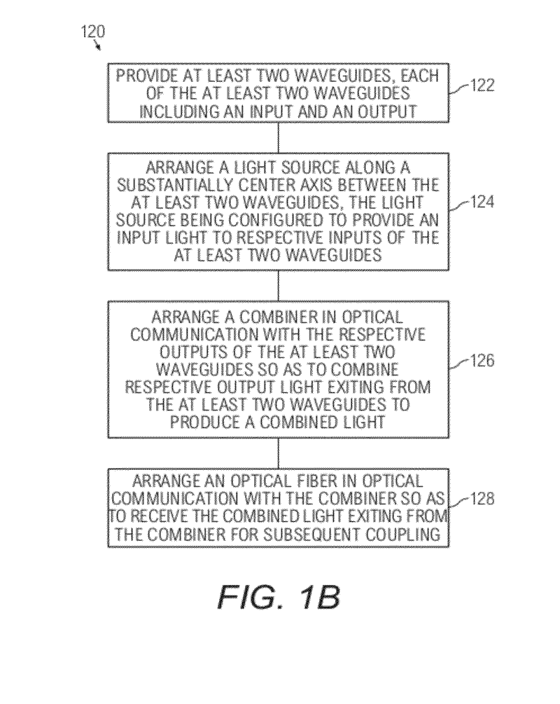

FIG. 1A shows a flow chart 100 illustrating an alignment method for a silicon photonics packaging, according to various embodiments.

At 102, a plurality of waveguides is provided, each of the plurality of waveguides including an input and an output. In various embodiments, the plurality of waveguides may be provided in parallel or at least respective portions of respective waveguides of the plurality of waveguides may be provided or arranged at least substantially in parallel.

At 104, a light source is arranged relative to the plurality of waveguides, the light source being configured to provide an input light to the input of at least one of the plurality of waveguides.

At 106, respective output light intensity exiting the outputs of the plurality of waveguides is detected.

At 108, a selected waveguide of the plurality of waveguides for subsequent coupling is identified based on the detected output light intensity.

In various embodiments, each of the plurality of waveguides may be configured to be substantially similar to each other.

In various embodiments, each of the plurality of waveguides may further include a mode converter extending from the input. The mode converter may include a changing cross-sectional dimension in a direction away from the input light. In the context of various embodiments, the term “mode converter” may mean a converter that changes or converts the mode size of, for example, a light.

In various embodiments, each of the plurality of waveguides may be respectively spaced apart at a predetermined distance between the respective inputs and the predetermined distance may be determined based on a mode size of the mode converter. The mode size of the mode converter may be dependent on a cross-section of the mode converter. The predetermined distance may be between about 1.5 μm and about 2.5 μm, e.g. between about 1.5 μm and about 2.0 μm or between about 2.0 μm and about 2.5 μm.

In various embodiments, the plurality of waveguides may include at least three waveguides.

In various embodiments, at 104, the light source may be aligned to a waveguide sandwiched between two other waveguides.

In various embodiments, the plurality of waveguides may include an odd number of waveguides. The light source may be aligned to a center waveguide of the odd number of waveguides.

In various embodiments, at 104, the light source may be aligned to a center position between two respective outermost waveguides of the plurality of waveguides.

In various embodiments, at 104, the light source may be aligned to a waveguide nearest to a center position between two respective outermost waveguides of the plurality of waveguides.

In context of various embodiments, the light source may be or may include a laser diode with a spot size in a range from about 1.5 μm to about 2.5 μm, e.g. about 1.5 μm to about 2.0 μm or about 2.0 μm to about 2.5 μm.

In the context of various embodiments, the method may further include providing a substrate, for example silicon (Si). The plurality of waveguides may be provided on the substrate. The light source may be arranged on the substrate.

In the context of various embodiments, the method may further include aligning optical components, for example one or more optical components, in optical communication with the selected waveguide. The optical components may be or may include one or more of a group consisting of receiver circuits, photodetectors and modulators.

FIG. 1B shows a flow chart 120 illustrating an alignment method for a silicon photonics packaging, according to various embodiments.

At 122, at least two waveguides are provided, each of the at least two waveguides including an input and an output.

At 124, a light source is arranged along a substantially center axis between the at least two waveguides, the light source being configured to provide an input light to respective inputs of the at least two waveguides.

At 126, a combiner is arranged in optical communication with the respective outputs of the at least two waveguides so as to combine respective output light exiting from the at least two waveguides to produce a combined light.

At 128, an optical fiber is arranged in optical communication with the combiner so as to receive the combined light exiting from the combiner for subsequent coupling.

In various embodiments, each of the at least two waveguides may further include a mode converter extending from the input. The at least two waveguides may be respectively spaced apart at a predetermined distance between the respective inputs and the predetermined distance may be determined based on a mode size of the respective mode converters.

In various embodiments, the respective output light exiting from the at least two waveguides may include polarization at least substantially perpendicular to each other.

In various embodiments, at 124, the light source may be arranged such that each of the at least two waveguides receives a substantially equal amount of the input light.

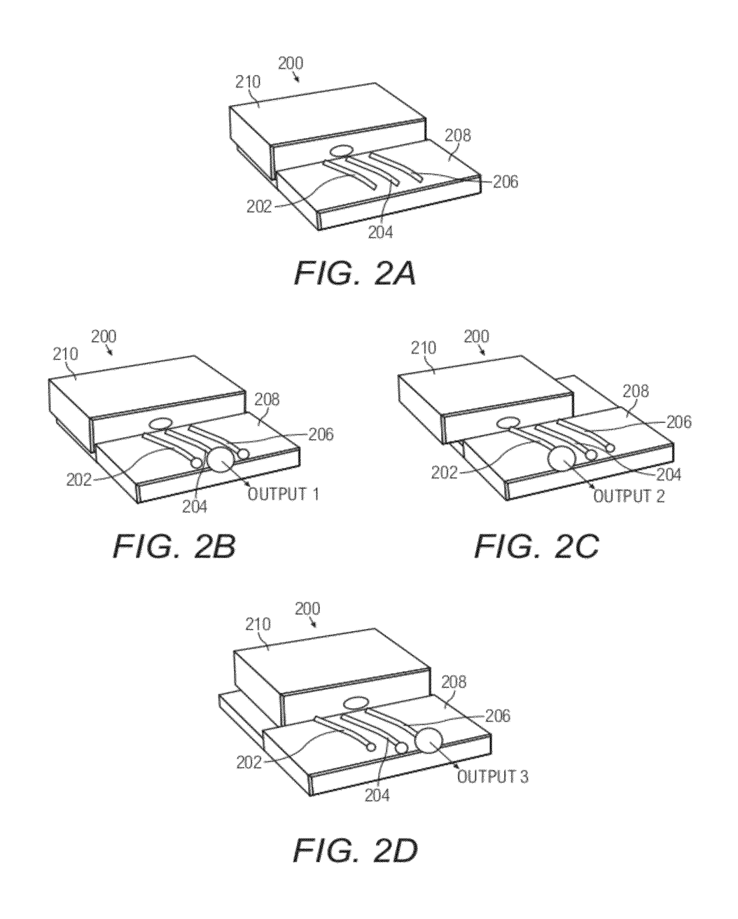

FIGS. 2A to 2D show perspective views of an alignment method for a silicon photonics packaging 200, according to various embodiments. The method is based on a silicon platform and may enhance the tolerance of horizontal alignment for the silicon photonics packaging 200. For the method, as shown in FIG. 2A, three waveguides (e.g. silicon (Si) waveguides) including a first waveguide, being an outermost waveguide, 202, a second waveguide, being a center waveguide, 204, and a third waveguide, being another outermost waveguide, 206, are placed or arranged on a substrate 208, e.g. a silicon (Si) substrate. A light source (e.g. a laser diode) 210 is also arranged on the substrate 208, relative to the first waveguide 202, the second waveguide 204, and the third waveguide 206, and may be aligned with any one of the first waveguide 202, the second waveguide 204, and the third waveguide 206, for example aligned with the second waveguide 204.

Each of the first waveguide 202, the second waveguide 204, and the third waveguide 206 includes an input proximal to the light source 210 such that the light source 210 may provide an input light to the input of at least one of the first waveguide 202, the second waveguide 204, and the third waveguide 206. Therefore, the respective inputs of the first waveguide 202, the second waveguide 204, and the third waveguide 206 may also be referred to as a coupling tip. Each of the first waveguide 202, the second waveguide 204, and the third waveguide 206 includes an output distal to the light source 210 such that the respective output light intensities exiting the outputs of the first waveguide 202, the second waveguide 204, and the third waveguide 206 may be detected. The respective outputs of the first waveguide 202, the second waveguide 204, and the third waveguide 206 may be coupled or in optical communication with, for example one or more optical components (e.g. receiver circuit(s) and/or photodetector(s) and/or modulator(s) and/or grating(s)), that may also be provided on the substrate 208 or external optical component(s).

The first waveguide 202, the second waveguide 204, and the third waveguide 206 are independent from each other. The first waveguide 202, the second waveguide 204, and the third waveguide 206 may be at least substantially similar to each other or identical. The first waveguide 202, the second waveguide 204, and the third waveguide 206 may be arranged at least substantially parallel to each other, for example the respective inputs or coupling tips of the first waveguide 202, the second waveguide 204, and the third waveguide 206 and/or respective portions of the first waveguide 202, the second waveguide 204 and the third waveguide 206 thereafter may be arranged at least substantially parallel to each other. After a particular distance, for example of between about 50 μm and about 200 μm, e.g. between about 50 μm and about 150 μm, between about 50 μm and about 100 μm or between about 100 μm and about 200 μm, the first waveguide 202, the second waveguide 204, and the third waveguide 206 may not be substantially parallel to each other and therefore may be further separated, for example by arranging or bending the first waveguide 202, the second waveguide 204, and the third waveguide 206 away from each other.

The spacing or distance between the respective inputs or coupling tips of adjacent waveguides may be between about 1.5 μm and about 2.5 μm, e.g. between about 1.5 μm and about 2.0 μm or between about 2.0 μm and about 2.5 μm, e.g. about 2 μm. The spacing or distance between the respective inputs or coupling tips between adjacent waveguides may depend on the light spot size or mode size of the light at the respective coupling tips. In various embodiment, the spacing may not be smaller than the light spot size width so that the light may not be coupled from one waveguide to an adjacent waveguide. In various embodiment, the spacing may be at least substantially same or close to the light spot size or width. For example, where the light spot size in a 0.18 μm×0.22 μm waveguide input or coupling tip is about 2 μm in diameter, the spacing may be about 2 μm.

The portions of the first waveguide 202, the second waveguide 204, and the third waveguide 206 arranged at least substantially parallel to each other may be spaced apart by a spacing of between about 1.5 μm and about 2.5 μm, e.g. between about 1.5 μm and about 2.0 μm or between about 2.0 μm and about 2.5 μm, e.g. about 2 μm, e.g. about 2 μm.

Each of the first waveguide 202, the second waveguide 204, and the third waveguide 206 may have a length of between about 50 μm and about 200 μm, e.g. about 50 μm and about 150 μm, between about 50 μm and about 100 μm or between about 100 μm and about 200 μm, at portions of the first waveguide 202, the second waveguide 204, and the third waveguide 206 in proximity with the respective inputs or coupling tips. Thereafter, each of the first waveguide 202, the second waveguide 204, and the third waveguide 206 may have a length that depends on the functional circuit(s) coupled to each of the first waveguide 202, the second waveguide 204, and the third waveguide 206. The first waveguide 202, the second waveguide 204, and the third waveguide 206 may have different total lengths.

Each of the first waveguide 202, the second waveguide 204, and the third waveguide 206 may include a mode converter extending from the respective inputs, where the mode converter is or includes a changing cross-sectional dimension in a direction away from the input light. In other words, the cross-sectional dimension may change in a direction from the respective inputs to the respective outputs of the respective first waveguide 202, second waveguide 204, and third waveguide 206. The mode converter may be in the form of a reverse taper where the cross-sectional dimension of each of the first waveguide 202, the second waveguide 204, and the third waveguide 206 may change, e.g. increases in a direction from the respective inputs towards the respective mainbodies or the respective outputs (i.e. along a longitudinal axis or length) of the respective first waveguide 202, second waveguide 204, and third waveguide 206. In various embodiments, each of the first waveguide 202, the second waveguide 204, and the third waveguide 206 may have a 0.18 μm (width)×0.22 μm (thickness) waveguide input or coupling tip. The dimensions of the respective mainbodies of each of the first waveguide 202, the second waveguide 204, and the third waveguide 206 may depend, for example on the material of each waveguide and/or the type of waveguide, among others. As a non-limiting example, the mainbody of a single mode silicon channel waveguide may have dimensions of 0.4-0.5 μm (width)×0.22 μm (thickness).

The spot size of the light from the light source 210 may be between about 1.5 μm and about 2.5 μm. The spot size of the lights coupled to the inputs of each of the first waveguide 202, the second waveguide 204, and the third waveguide 206 having a mode-size converter (e.g. a reverse taper) may be about 2 μm in diameter. As the respective lights traverse through the respective first waveguide 202, second waveguide 204, and third waveguide 206 with the reverse taper, the mode size or spot size of the light may decrease and may approach the size of the respective mainbodies of each of the first waveguide 202, the second waveguide 204, and the third waveguide 206, for example approximately 0.4-0.5 μm×0.22 μm. This may be due to, for example, light leaking out of the waveguide core at the waveguide input tip, such that the mode size in the mainbody of the waveguide is smaller than the mode size at the waveguide input tip as the light traverses through the waveguide.

The spacing or distance between the respective inputs of adjacent waveguides for coupling with the light from the light source 210 may be determined by the mode size of the mode converter of each of the first waveguide 202, the second waveguide 204, and the third waveguide 206. In other words, each of the first waveguide 202, the second waveguide 204, and the third waveguide 206 may be respectively spaced apart at a predetermined distance between the respective inputs, where the predetermined distance may be determined based on a mode size of the mode converter, e.g. dependent on a cross-section of the mode converter. The spacing or distance between the respective inputs of adjacent waveguides may be between about 1.5 μm and about 2.5 μm, e.g. between about 1.5 μm and about 2.0 μm or between about 2.0 μm and about 2.5 μm.

As shown in FIG. 2B, the light source 210 may be arranged relative to the first waveguide 202, the second waveguide 204, and the third waveguide 206 such that the light from the light source 210 may be provided as an input light to the input of the second waveguide 204. The light then traverses through the second waveguide 204 and provides an output light, e.g. as ‘Output 1’.

As shown in FIG. 2C, the light source 210 may be arranged relative to the first waveguide 202, the second waveguide 204, and the third waveguide 206 such that the light from the light source 210 may be provided as an input light to the input of the first waveguide 202. The light then traverses through the first waveguide 202 and provides an output light, e.g. as ‘Output 2’.

As shown in FIG. 2D, the light source 210 may be arranged relative to the first waveguide 202, the second waveguide 204, and the third waveguide 206 such that the light from the light source 210 may be provided as an input light to the input of the third waveguide 206. The light then traverses through the third waveguide 206 and provides an output light, e.g. as ‘Output 3’.

Based on the output light intensity that is detected from each of the first waveguide 202, the second waveguide 204, and the third waveguide 206, a waveguide may be identified from the first waveguide 202, the second waveguide 204, and the third waveguide 206 for subsequent coupling, for example to one or more optical components.

The fabrication and assembly steps for the silicon photonics packaging 200 may follow the standard silicon photonics platform fabrication steps. After light source 210 bonding, an inspection with the light source 210 switched on may help to identify which of the first waveguide 202, the second waveguide 204, and the third waveguide 206 or their associated respective circuits may be better aligned with the light source 210. Subsequently, packaging processes such as fiber pigtailing processes, may be carried out for the aligned waveguide.

The alignment method of various embodiments using the first waveguide 202, the second waveguide 204, and the third waveguide 206 may provide a larger alignment tolerance and hence a higher yield. Furthermore, the fabrication process for fabricating the first waveguide 202, the second waveguide 204, the third waveguide 206 and the light source 210 on the substrate 208 for employing the alignment method may be simpler.

In various embodiments, the coupling or interaction between the waveguides should be minimised or avoided. Simulations may be performed to determine the light coupling between two waveguides or waveguide tips. For the simulations, each waveguide may be a silicon-on-insulator (SOI) waveguide of a thickness or height of about 220 nm and a width of about 180 nm.

For example, the light spot size in a 0.18 μm×0.22 μm waveguide input or coupling tip may be about 2 μm in diameter. The light propagation length may be about 50 μm. The spacing or distance between the two waveguide inputs or coupling tips may range from between about 1.6 μm and about 2 μm.

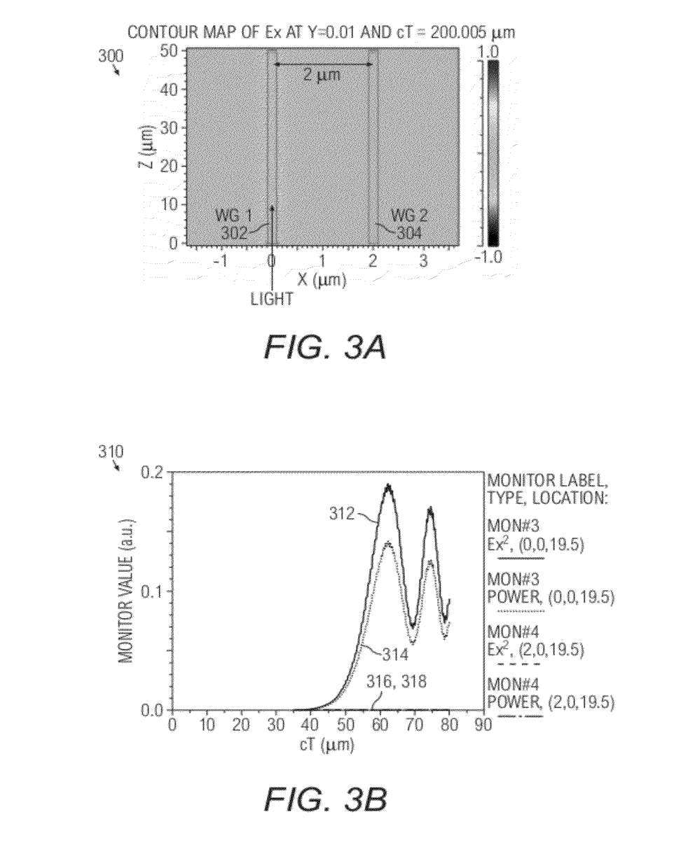

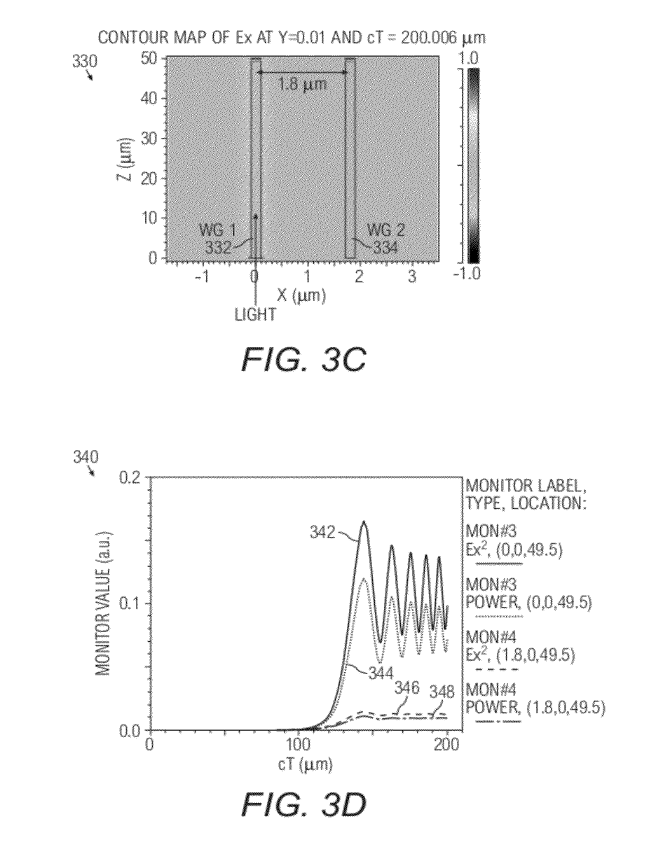

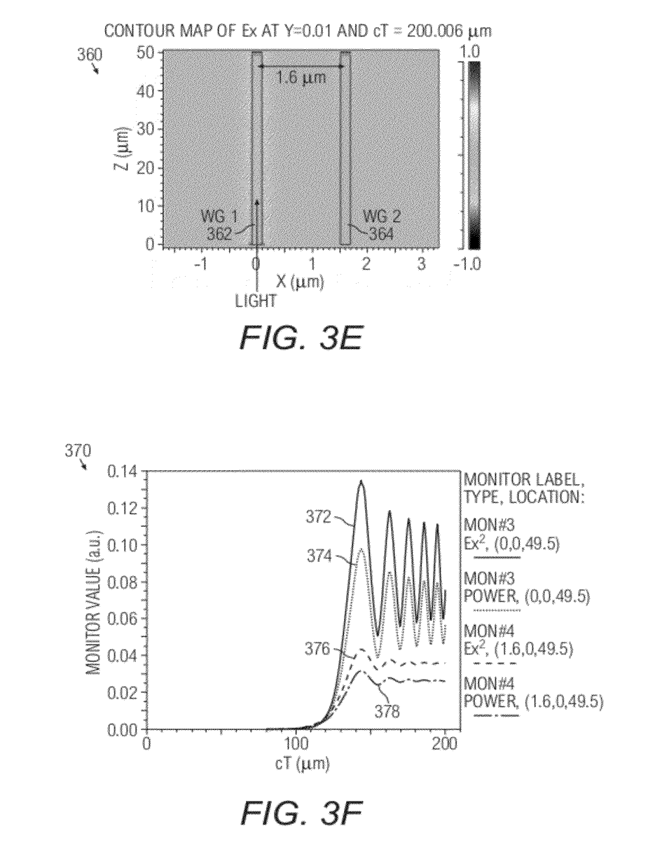

FIGS. 3A and 3B show respectively the simulated results for the contour map 300 of the x-component of electric field (Ex) and a plot 310 of the coupling between two waveguide tips with a spacing of about 2 μm. The term “cT” in FIG. 3B (also FIGS. 3D and 3F) refers to the product of the speed of light and time, i.e. the distance that the light has travelled. The contour map 300 shows two waveguides, WG1 302 and WG2 304, with the central axis of the waveguides spaced apart by about 2 μm. The simulation may be carried out with an input light launched into WG1 302.

The plot 310 shows the simulated results for Ex² 312 and light power 314 in WG1 302 and the simulated results for Ex² 316 and light power 318 in WG2 304. As “Ex” refers to the electric field amplitude, “Ex²” is proportional to the light power 318. The plot 310 shows that there is minimal or no interaction between WG1 302 and WG2 304, as the magnitudes for Ex² 316 and light power 318 in WG2 304 are substantially zero. Therefore, there is minimal or no leakage due to coupling between the waveguides WG1 302 and WG2 304, so that the two waveguides WG1 302 and WG2 304 may be independent from each other.

FIGS. 3C and 3D show respectively the simulated results for the contour map 330 of the x-component of electric field (Ex) and a plot 340 of the coupling between two waveguide tips with a spacing of about 1.8 μm. The contour map 330 shows two waveguides, WG1 332 and WG2 334, with the central axis of the waveguides spaced apart by about 1.8 μm. The simulation may be carried out with an input light launched into WG1 332.

The plot 340 shows the simulated results for Ex² 342 and light power 344 in WG1 332 and the simulated results for Ex² 346 and light power 348 in WG2 334. The plot 340 shows that there is interaction or cross-talk between WG1 332 and WG2 334, where there is a transfer of power or light leakage from WG1 332 to WG2 334, resulting in an increase in Ex² 346 and light power 348 in WG2 334. There is weak coupling between the two waveguides WG1 332 and WG2 334, which causes light in WG1 332 being split into the neighboring waveguide WG2 334.

FIGS. 3E and 3F show respectively the simulated results for the contour map 360 of the x-component of electric field (Ex) and a plot 370 of the coupling between two waveguide tips with a spacing of about 1.6 μm. The contour map 360 shows two waveguides, WG1 362 and WG2 364, with the central axis of the waveguides spaced apart by about 1.6 μm. The simulation may be carried out with an input light launched into WG1 362.

The plot 370 shows the simulated results for Ex² 372 and light power 374 in WG1 362 and the simulated results for Ex² 376 and light power 378 in WG2 364. The plot 370 shows that there is interaction or cross-talk between WG1 362 and WG2 364, where there is a transfer of power or light leakage from WG1 362 to WG2 364, resulting in an increase in Ex² 376 and light power 378 in WG2 364. There is strong coupling between the two waveguides WG1 362 and WG2 364, which causes light in WG1 362 being split into the neighboring waveguide WG2 364.

The results of FIGS. 3B, 3D and 3F show that there may be interaction between the two waveguides when the spacing between the two waveguides is decreased, for example below the light spot size at the respective waveguide inputs or coupling tips. The simulation results show that interaction may occur for a spacing of less than 2 μm for a waveguide of a thickness or height of about 220 nm and a width of about 180 nm. It should be appreciated that the spacing or distance provided between the two waveguide inputs or coupling tips may depend on the light spot size at the respective waveguide inputs or coupling tips.

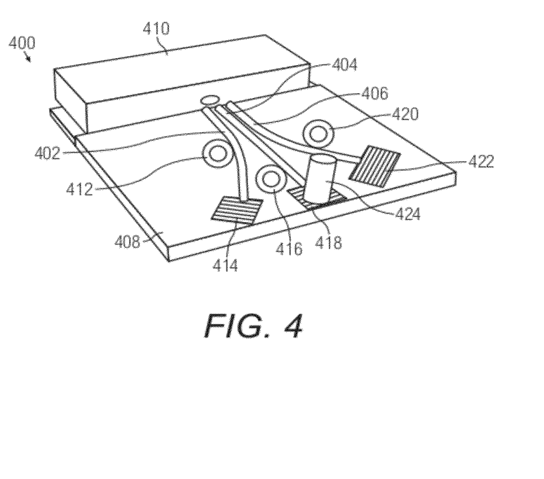

FIG. 4 shows a perspective view of a silicon photonics packaging 400 with an alignment method of various embodiments. The silicon photonics packaging 400 may be for example a silicon based optical transmitter packaging.

The silicon photonics packaging 400 includes three waveguides (e.g. silicon waveguides) including a first waveguide 402, a second waveguide 404, and a third waveguide 406, placed or arranged on a substrate 408, e.g. a silicon (Si) substrate. A light source (e.g. a laser diode) 410 is also arranged on the substrate 408, relative to the first waveguide 402, the second waveguide 404, and the third waveguide 406, and may be aligned with any one of the first waveguide 402, the second waveguide 404, and the third waveguide 406, for example aligned with the second waveguide 404.

It should be appreciated that the first waveguide 402, the second waveguide 404, the third waveguide 406 and the light source 410 may be similar to the first waveguide 202, the second waveguide 204, the third waveguide 206 and the light source 210 as described in the context of FIGS. 2A to 2D and that the silicon photonics packaging 400 may be similar to the silicon photonics packaging 200 as described in the context of FIGS. 2A to 2D.

As shown in FIG. 4, after a particular distance, the first waveguide 402, the second waveguide 404 and the third waveguide 406 may not be substantially parallel to each other and therefore may be further separated, for example by arranging or bending the first waveguide 402, the second waveguide 404 and the third waveguide 406 away from each other. For example, after a distance of between about 50 μm and about 200 μm, e.g. between about 50 μm and about 150 μm, between about 50 μm and about 100 μm or between about 100 μm and about 200 μm, the first waveguide 402, the second waveguide 404 and the third waveguide 406 may be arranged or bent away from each other.

The silicon photonics packaging 400 may further include one or more other optical components coupled to or in optical communication with one or more of the first waveguide 402, the second waveguide 404 and the third waveguide 406. As shown in FIG. 4, the silicon photonics packaging 400 may include a filter (e.g. a ring resonator) 412 and/or a surface grating 414 optically coupled to the first waveguide 402 to form a first waveguide circuit, and/or a filter (e.g. a ring resonator) 416 and/or a surface grating 418 optically coupled to the second waveguide 404 to form a second waveguide circuit, and/or a filter (e.g. a ring resonator) 420 and/or a surface grating 422 optically coupled to the third waveguide 406 to form a third waveguide circuit. Therefore, the silicon photonics packaging 400 may include three independent waveguide circuits, which may be identical to each other. The silicon photonics packaging 400 may further include one or more optical fibers. As a non-limiting example, FIG. 4 shows an optical fiber 424 optically coupled to the second waveguide 404.

There may be minimal or no interaction between the first waveguide 402, the second waveguide 404 and the third waveguide 406 or their associated circuits.

Simulations may be performed based on the mode-matching between the light source and the inputs of the waveguides to determine the coupling efficiency across the lateral misalignment. For the simulations, the light source (e.g. laser diode) spot size may be about 2 μm in diameter and the beam size at the reverse taper tip (i.e. input or coupling tip) of the waveguide may have a width or diameter of about 2 μm. The coupling efficiency may be normalized.

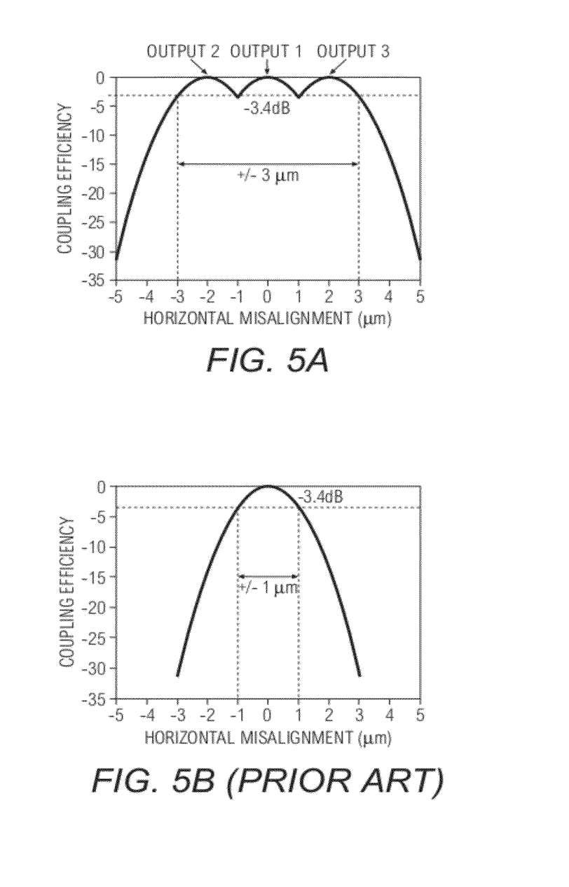

The light source may be aligned with the central waveguide (e.g. 204, 404). Where the light source may be misaligned with the central waveguide (e.g. 204, 404) within about +/−1 μm, the coupling efficiency may be reduced by less than approximately 3 dB, as shown in FIG. 5A illustrating a plot of normalized coupling efficiency between a light source and three silicon waveguides, according to various embodiments. FIG. 5A shows three peaks corresponding to three outputs: Output 1 corresponding to a central waveguide (e.g. 204, 404), Output 2 corresponding to a waveguide arranged on one side of the central waveguide (e.g. 202, 402) and Output 3 corresponding to another waveguide arranged on another side of the central waveguide (e.g. 206, 406).

Where the light source may be misaligned with the central waveguide by more than approximately +/−1 μm, the light source may become better aligned with a neighboring or adjacent waveguide and therefore the light from the light source may be coupled into the neigbouring waveguide.

As shown in FIG. 5A illustrating the coupling efficiency of the best aligned waveguide in the three waveguides across the lateral misalignment, the lateral 3.4 dB tolerance of the three waveguide scheme is approximately +/−3 μm. As compared to a +/−1 μm 3.4 dB tolerance of a one-waveguide alignment of the prior art as shown in FIG. 5B, the tolerance of the three-waveguide-scheme of various embodiments may be extended to three times (i.e. +/−3 μm). Therefore, various embodiments may ensure that the fiber to waveguide alignment error may be less than approximately +/−1 μm, with a <3 dB performance.

It should be appreciated that in the context of various embodiments, the number of waveguides may not be limited to three and that the silicon photonics packagings 200, 400 may include two waveguides, four waveguides, five waveguides, six waveguides or any higher number of waveguides. In some embodiments, the silicon photonics packaging may include an odd number of waveguides (e.g. 3, 5, 7, 9, etc.). The number of waveguides provided may be determined by the accumulated misalignment in the assembly process.

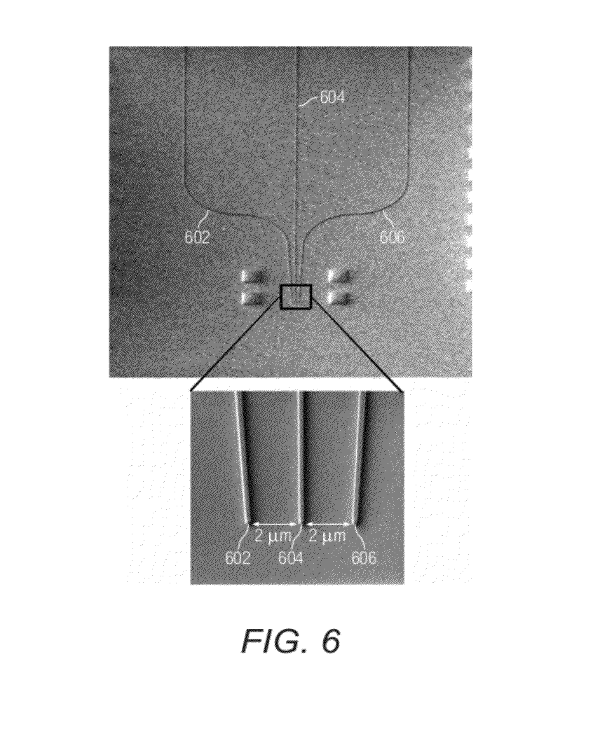

FIG. 6 shows scanning electron microscope (SEM) images of fabricated waveguides 602, 604, 606, according to various embodiments, which may be employed for example in the embodiments of silicon photonics packagings 200, 400.

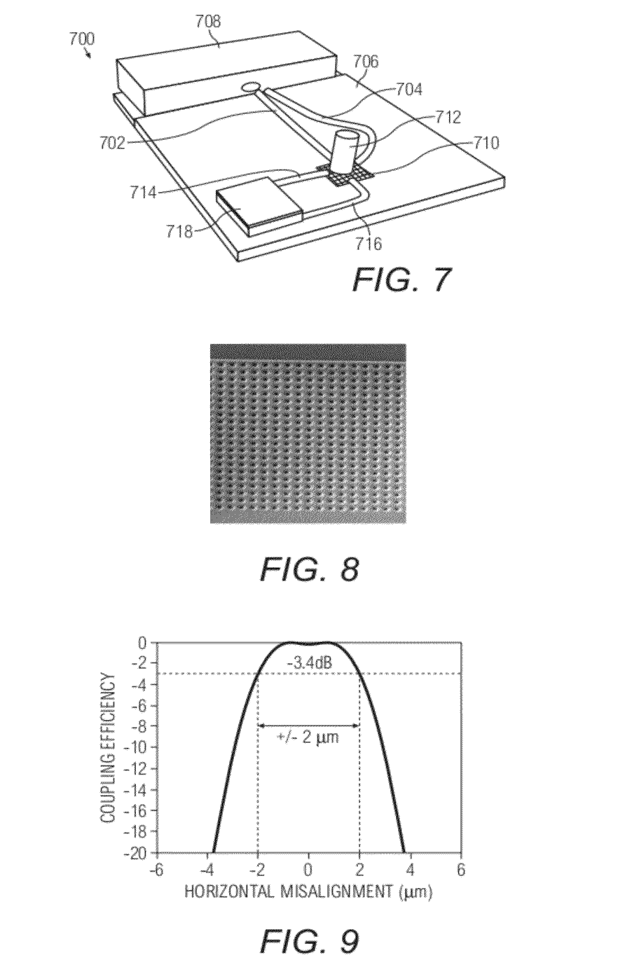

FIG. 7 shows a perspective view of an alignment method for a silicon photonics packaging 700, according to various embodiments. The silicon photonics packaging 700 may be for example a silicon based optical transceiver packaging.

The method is based on a silicon platform and may enhance the tolerance of horizontal alignment for the silicon photonics packaging 700. For the method, as shown in FIG. 7, two waveguides (e.g. silicon waveguides) including a first waveguide 702 and a second waveguide 204 are placed or arranged on a substrate 706, e.g. a silicon (Si) substrate. A light source (e.g. a laser diode) 708 is also arranged on the substrate 706, relative to the first waveguide 702 and the second waveguide 704.

Each of the first waveguide 702 and the second waveguide 704 includes an input proximal to the light source 708 such that the light source 708 may provide an input light to the respective inputs of the first waveguide 702 and the second waveguide 704. The light source 708 may be arranged along a substantially center axis between the first waveguide 702 and the second waveguide 704 so as to provide an input light to the respective inputs of the first waveguide 702 and the second waveguide 704. Each of the first waveguide 702 and the second waveguide 704 includes an output distal to the light source 708.

For the silicon photonics packaging 700, a combiner (e.g. a two-dimensional (2D) surface grating or grating coupler) 710 may be arranged in optical communication with the respective outputs of the first waveguide 702 and the second waveguide 704 so as to combine the respective output lights exiting from the first waveguide 702 and the second waveguide 704 to produce a combined light. At the combiner 710, the first waveguide 702 and the second waveguide 704 are arranged at least substantially perpendicular to each other. The combiner 710 may have a substantially square shape of dimensions of approximately 12 μm×12 μm.

FIG. 8 shows a scanning electron microscope (SEM) image of a top view of a two-dimensional (2D) grating that may be employed as the combiner 710. The 2D grating includes a plurality of voids arranged in a uniform and symmetrical grid pattern. In various embodiments, with normal incidence and a symmetric grating, the achievable coupling efficiency may be approximately 50%. However, it should be appreciated that an asymmetric or blazed grating may be employed, which may provide improved coupling efficiency.

An optical fiber 712 may be arranged in optical communication with the combiner 710 so as to receive the combined light exiting from the combiner 710 for subsequent coupling. Therefore, the first waveguide 702 and the second waveguide 704 may optically couple the light from the light source 708 to the combiner 710 and then to the optical fiber 712.

The silicon photonics packaging 700 may further include one or more additional waveguides (e.g. silicon waveguides) 714, 716, optically coupled to the combiner 710, at respective one ends. The waveguides 714, 716 may be optically coupled or in optical communication, at the respective other ends, with, for example one or more optical components (e.g. receiver circuit(s) and/or photodetector(s) and/or modulator(s)), as represented by 718, that may also be provided on the substrate 706 or external optical component(s). Providing one or more optical components on the substrate 706 allows more functions to be integrated on the silicon photonics packaging 700.

The first waveguide 702 and the second waveguide 704 are independent from each other. The first waveguide 702 and the second waveguide 704 may be at least substantially similar to each other or identical. The first waveguide 702 and the second waveguide 204 may be arranged at least substantially parallel to each other towards their respective inputs. The spacing or distance between the respective inputs of the first waveguide 702 and the second waveguide 704 may be between about 1.5 μm and about 2.5 μm, e.g. between about 1.5 μm and about 2.0 μm or between about 2.0 μm and about 2.5 μm, e.g. about 2 μm. The portions of the first waveguide 702 and the second waveguide 704 arranged at least substantially parallel to each other may be spaced apart by a spacing of between about 1.5 μm and about 2.5 μm, e.g. between about 1.5 μm and about 2.0 μm or between about 2.0 μm and about 2.5 μm, e.g. about 2 μm, e.g. about 2 μm. After a particular distance, the first waveguide 702 and the second waveguide 704 may not be substantially parallel to each other and therefore may be further separated, for example by arranging or bending the first waveguide 702 and the second waveguide 704 away from each other.

Each of the first waveguide 702 and the second waveguide 704 may include a mode converter extending from the respective inputs, where the mode converter is or includes a changing cross-sectional dimension in a direction away from the input light. In other words, the cross-sectional dimension may change in a direction from the respective inputs to the respective outputs of the respective first waveguide 702 and the second waveguide 704. The mode converter may be in the form of a reverse taper where the cross-sectional dimension of each of the first waveguide 702 and the second waveguide 704 may change, e.g. increases in a direction from the respective inputs to the respective outputs of the respective first waveguide 702 and second waveguide 704.

The spot size of the light from the light source 708 may be between about 1.5 μm and about 2.5 μm. The spot size of the lights coupled to the inputs of each of the first waveguide 702 and the second waveguide 704 having a mode-size converter (e.g. a reverse taper) may be about 2 μm in diameter.

The spacing or distance between the respective inputs of the first waveguide 702 and the second waveguide 704 for coupling with the light from the light source 708 may be determined by the mode size of the mode converter of each of the first waveguide 702 and the second waveguide 704. In other words, each of the first waveguide 702 and the second waveguide 704 may be respectively spaced apart at a predetermined distance between the respective inputs, where the predetermined distance may be determined based on a mode size of the mode converter, e.g. dependent on a cross-section of the mode converter. The spacing or distance between the respective inputs of the first waveguide 702 and the second waveguide 704 may be between about 1.5 μm and about 2.5 μm, e.g. between about 1.5 μm and about 2.0 μm or between about 2.0 μm and about 2.5 μm.

In various embodiments, there may be a 2 μm spacing between the first waveguide 702 and the second waveguide 704, which is to match the mode size of the waveguide tip. The light source 708 may be aligned at the center between the first waveguide 702 and the second waveguide 704. Each of the first waveguide 702 and the second waveguide 704 may receive approximately 50% (−3.4 dB) of the light from the light source 708. The lights traversing in the first waveguide 702 and the second waveguide 704 may be combined at the combiner (e.g. a 2D surface grating) 710 and may enter or couple to the optical fiber 712. The respective light components from the first waveguide 702 and the second waveguide 704 may not interfere with each other in the optical fiber 712 as their polarizations are at least substantially perpendicular to each other.

The combiner 710 also works as a polarization splitter. The lights traversing in the first waveguide 702 and the second waveguide 704 may be at least substantially same. As the first waveguide 702 and the second waveguide 704 are arranged at least substantially perpendicular to each other when optically coupled to the combiner 710, the polarization status of the lights from the first waveguide 702 and the second waveguide 704 may be at least substantially perpendicular to each other when combined by the combiner 710.

Therefore, the method of various embodiments to enhance the tolerance of horizontal alignment for a silicon photonics packaging may include placing or arranging two identical and independent silicon waveguides and employ a 2D grating to combine the lights from the two waveguides and couple the light into an optical fiber.

The fabrication and assembly steps for the silicon photonics packaging 700 may follow the standard silicon photonics platform fabrication steps, without additional steps required. After light source 708 bonding, an inspection with the light source 708 switched on may help to identify which of the first waveguide 702 and the second waveguide 704 or their associated respective circuits may be better aligned with the light source 708. Subsequently, packaging processes such as fiber pigtailing processes, may be carried out for the aligned waveguide.

While not shown in FIG. 7, a fiber block of dimensions of approximately 2.5 mm×2.5 mm may be provided for packaging, for holding the optical fiber 712 and aligning the optical fiber 712 with the combiner 710. The fiber block may have an opening in a substantially central position in which the optical fiber 712 may pass through. The opening may be sufficient for a fiber (e.g. optical fiber 712) of a diameter of about 125 μm to pass through. The fiber block may be affixed to the substrate 706. The fiber block may be used or provided in the fiber assembly step after the bonding of the light source (e.g. a laser chip, e.g. a laser diode) 708 on the substrate (e.g. silicon chip) 706.

Simulations may be performed based on the mode-matching between the light source and the inputs of the waveguides to determine the coupling efficiency across the lateral misalignment. For the simulations, the light source (e.g. laser diode) spot size may be about 2 μm in diameter and the beam size at the reverse taper tip (i.e. input) may be about 2 μm width. The coupling efficiency may be normalized.

FIG. 9 shows a plot of normalized coupling efficiency between a light source and two silicon waveguides with a combiner, according to various embodiments, illustrating that the light source attachment tolerance may be increased to approximately +/−2 μm at the 3 dB bandwidth.

Where the light source may be misaligned to be closer to one of the two waveguides (e.g. 702 or 704), the light source may become better aligned with one of the waveguides and therefore more light from the light source may be coupled into the better aligned waveguide. At the combiner (e.g. a 2D grating), the lights from the two waveguides are combined and coupled into an optical fiber.

It should be appreciated that in the context of various embodiments, the number of waveguides may not be limited to two and that the silicon photonics packaging 700 may include three waveguides, four waveguides, five waveguides, six waveguides or any higher number of waveguides. The number of waveguides provided may be determined by the accumulated misalignment in the assembly process.

While the preferred embodiments of the devices and methods have been described in reference to the environment in which they were developed, they are merely illustrative of the principles of the inventions. Other embodiments and configurations may be devised without departing from the spirit of the inventions and the scope of the appended claims.

We claim:

1. An alignment method for a silicon photonics packaging, the method comprising:
providing a plurality of waveguides, each of the plurality of waveguides comprising an input and an output;
arranging a light source relative to the plurality of waveguides, the light source being configured to provide an input light to the input of at least one of the plurality of waveguides;
detecting respective output light intensity exiting the outputs of the plurality of waveguides; and
identifying based on the detected output light intensity a selected waveguide of the plurality of waveguides for subsequent coupling.

2. The alignment method of claim 1, wherein providing the plurality of waveguides comprises providing the plurality of waveguides in parallel.

3. The alignment method of claim 1, wherein each of the plurality of waveguides is configured to be substantially similar to each other.

4. The alignment method of claim 1, wherein each of the plurality of waveguides further comprises a mode converter extending from the input.

5. The alignment method of claim 4, wherein the mode converter comprises a changing cross-sectional dimension in a direction away from the input light.

6. The alignment method of claim 4, wherein each of the plurality of waveguides is respectively spaced apart at a predetermined distance between the respective inputs and the predetermined distance is determined based on a mode size of the mode converter.

7. The alignment method of claim 6, wherein the predetermined distance is between about 1.5 μm and about 2.5 μm.

8. The alignment method of claim 1, wherein the plurality of waveguides comprises at least three waveguides.

9. The alignment method of claim 1, wherein arranging the light source relative to the plurality of waveguides comprises aligning the light source to a waveguide sandwiched between two other waveguides.

10. The alignment method of claim 1, wherein the plurality of waveguides comprises an odd number of waveguides.

11. The alignment method of claim 10, wherein arranging the light source relative to the plurality of waveguides comprises aligning the light source to a center waveguide of the odd number of waveguides.

12. The alignment method of claim 1, wherein arranging the light source relative to the plurality of waveguides comprises aligning the light source to a center position between two respective outermost waveguides of the plurality of waveguides.

13. The alignment method of claim 1, wherein arranging the light source relative to the plurality of waveguides comprises aligning the light source to a waveguide nearest to a center position between two respective outermost waveguides of the plurality of waveguides.

14. The alignment method of claim 1, wherein the light source comprises a laser diode with a spot size in a range from about 1.5 μm to about 2.5 μm.

15. The alignment method of claim 1, further comprising aligning optical components in optical communication with the selected waveguide.

16. An alignment method for a silicon photonics packaging, the method comprising:
providing at least two waveguides, each of the at least two waveguides comprising an input and an output;
arranging a light source along a substantially center axis between the at least two waveguides, the light source being configured to provide an input light to respective inputs of the at least two waveguides;
arranging a combiner in optical communication with the respective outputs of the at least two waveguides so as to combine respective output light exiting from the at least two waveguides to produce a combined light; and
arranging an optical fiber in optical communication with the combiner so as to receive the combined light exiting from the combiner for subsequent coupling.

17. The alignment method of claim 16, wherein each of the at least two waveguides further comprises a mode converter extending from the input.

18. The alignment method of claim 17, wherein the at least two waveguides are respectively spaced apart at a predetermined distance between the respective inputs and the predetermined distance is determined based on a mode size of the respective mode converters.

19. The alignment method of claim 16, wherein the respective output light exiting from the at least two waveguides comprises polarization at least substantially perpendicular to each other.

20. The alignment method of claim 16, wherein arranging the light source along the substantially center axis between the at least two waveguides comprises arranging the light source such that each of the at least two waveguides receives a substantially equal amount of the input light.
